(19) United States
(12) Patent Application Publication
(10) Pub. No.: US 2017/0362041 A1
(43) Pub. Date: Dec. 21, 2017

(54) CONVEYING DEVICE

(71) Applicant: WRH Walter Reist Holding AG, Ermatingen (CH)

(72) Inventor: Carl Conrad Mäder, Hittnau (CH)

(21) Appl. No.: 15/546,099

(22) PCT Filed: Jan. 22, 2016
(86) PCT No.: PCT/CH2016/000014

§ 371 Date: Jul. 25, 2017

(30) Foreign Application Priority Data
Jan. 29, 2015 (CH) 00109/15

(51) Int. Cl. B65G 47/96; B65G 47/40; B65G 43/08

(52) U.S. Cl. CPC B65G 47/962; B65G 47/40; B65G 43/08

(57) ABSTRACT

A conveying unit that includes a base body, a conveying member with a rest element forming a rest surface and receiving a conveyed object, an inclining body that is connected to the conveying member, and an inclining mechanism for inclining the inclining body and, with this body, also the rest surface, with respect to the base body towards a delivery side for the purpose of delivering the conveyed object. The conveying member includes an encompassing frame that at least partly encompasses the rest surface of the rest element for the object to be conveyed and can therefore secure the conveyed object against sliding away from the rest surface, and the encompassing frame can be lifted to above the rest surface or be lowered to below the rest surface via control elements on the conveying unit, on inclining the inclining body to the delivery side.

### BACKGROUND OF THE INVENTION

### FIELD OF THE INVENTION

The invention lies in the field of conveying technology and relates to a conveying unit for a conveying device for conveying objects to be conveyed, wherein the conveying unit includes a base body, a conveying member with a rest element, which forms a rest surface and which is for receiving a conveyed object, an inclining body which is connected to the conveying member, and an inclining mechanism for inclining the inclining body and, with this body, also the rest surface, with respect to the base body towards a delivery side for the purpose of delivering the conveyed object. The invention moreover relates to a conveying device with at least one such conveying unit. The invention moreover relates to a method for conveying and delivering conveyed objects with such a conveying device.

### DESCRIPTION OF RELATED ART

Conveying devices which envisage a lateral inclining of the rest surface for the conveyed object in order, considered in the conveying direction, to deliver this to the side onto a take-over device are known. Here, the conveyed object slides away from the rest surface, which is inclined to the side and is thus delivered or transferred onto the take-over device.

The published document WO 2013/075714 A1 describes a conveying device with a conveying unit, which can be pivoted via a common, centrally arranged pivot (pivot axis), considered in the conveying direction, to a first delivery side as well as to a second delivery side which lies opposite the first one. Thereby, the rest surface for the conveyed object is inclined towards the respective side.

The conveying device has the disadvantage that the lateral encompassing frame represents an obstacle to the conveyed objects, which slide away. Moreover, the conveying device and thus also the complete weight of the conveyed object bears exclusively upon the mentioned pivot (pivot axis). Such a linear mounting tends to be unstable, particularly if the conveyed object is not arranged centrally.

The published document WO 2011/139147 A1 likewise describes a conveying device with a conveying unit which can be pivoted via a common, centrally arranged pivot (pivot axis), considered in the conveying direction, to first delivery side as well as to a second one which lies opposite the first one. Here, the carrier shell of the conveying unit is inclined to the respective side. The conveying device has the disadvantage that the conveyed object is not secured against an unintended sliding-away from the conveying surface by way of an encompassing frame. Although the shell-like design of the rest surface provides a certain protection against such a sliding-away, the rest surface however is not designed in a continuously plane manner. Moreover, here too, the conveying unit and thus the complete weight of the conveyed object bear only on one pivot (pivot axis).

The published document EP 1 719 721 B1 likewise describes a conveying device with a conveying unit which along the movement path can be pivoted to a delivery side via a pivot [axis]. Since the pivot, which is to say pivot axis, is arranged asymmetrically, the rest surface, however, can only be inclined to one inside. The conveying member moreover has no encompassing frame. In return the rest surface is designed in a shell-like manner and is not therefore plane.

The published document EP 2 448 848 B1 then again describes a conveying unit in the embodiment of a double carrier shell. The two carrier shells are individually pivotable about a centrally arranged, common pivot axis, wherein a first carrier shell is pivotable to a first delivery side and the second carrier shell is pivotable to a second, opposite delivery side. Accordingly, the rest surfaces of the two carrier shells are each inclinable only to one delivery side. The carrier shells do not include an encompassing frame towards the delivery sides, which would secure the conveyed object against an unintended sliding-away from the rest surface.

Moreover, the construction of the conveying unit and the control for the individual pivoting of the carrier shells is very complicated. Moreover, the rest surface for the conveyed object per carrier shell part is significantly smaller because of the division of the carrier shell into two individual parts.

### SUMMARY OF THE INVENTION

It is the object of a first aspect of the invention to put forward a conveying unit that includes an encompassing frame, which, on the one hand, secures the conveyed object against an unintended sliding-away from the rest surface and, on the other hand, does not inhibit the sliding-away of the conveyed object given a positively activated delivery.

Moreover, it is also an object of a further aspect of the invention to suggest a conveying unit, which, considered in the conveying direction, permits the inclining of the rest surface of the conveying unit to both sides, wherein the pivoting mechanism for executing the inclining movement should be stable, robust and despite this be as simple as possible with regard to the design.

The conveying unit according to the invention and according to a first aspect of the invention is characterised in that the conveying member includes a single-part or multi-part encompassing frame, which at least partly encompasses the rest surface of the rest element for the object to be conveyed and can therefore secure the conveyed object against sliding away from the rest surface, and the encompassing frame can be lifted to above the rest surface or be lowered to below the rest surface, via control elements on the conveying unit, on inclining the inclining body to the delivery side.

The encompassing frame can be lifted to above the rest surface or lowered to below the rest surface, in particular transversely to the delivery direction of the conveyed objects, in the region of the delivery opening to be released. The movement of the encompassing frame for the release of the delivery opening in particular runs exclusively transversely to the delivery direction.

The inclining mechanism in particular connects the inclining body to the base body.

The conveying unit according to the invention and according to a second aspect of the invention is characterised in that the inclining mechanism includes a first inclining joint with a first pivot axis for pivoting the inclining body towards to a first delivery side, and a second inclining joint with a second pivot axis for pivoting the inclining body towards a second delivery side, which lies opposite the first delivery side, as well as a connecting element, which connects the inclining joints to one another. The inclining of the inclining body is effected by way of the pivoting about the pivot axis of the inclining joints.

The two aspects of the invention, which are mentioned above and which, on the one hand, relate to the inclining mechanism and, on the other hand, to the encompassing frame can be considered as independent inventions. However, the first and the second aspect of the invention can also be combined with one another.

However, the conveying unit according to the second aspect of the invention can also include an encompassing frame, which is stationary relative to the rest surface.

Moreover, it is also possible for the conveying unit according to the second aspect of the invention not to include an encompassing frame. Thus, for example, one can make do without an encompassing frame if the conveying speeds are low or if the acceleration forces acting upon the conveying members are low.

The rest surface is then brought into an inclined position by way of pivoting the inclining body towards one of the delivery sides.

The inclining mechanism is connected to the inclining body via the first inclining joint, in particular in a manner such that the inclining body can be pivoted with respect to the base body about the first pivot axis via the first inclining joint and is therefore inclinable to the first delivery side.

The first inclining joint in particular articulately connects the inclining body to the connecting element.

The inclining mechanism is moreover connected to the base body via the second inclining joint, in particular in a manner such that the inclining body is pivotable with respect to the base body about the second pivot axis via the second inclining joint and is thus inclinable to the second delivery side.

The second inclining joint in particular articulately connects the base body to the connecting element.

The pivot axes of the first and second inclining joint in particular are arranged offset to one another.

The pivot axes of the first and second inclining joint in particular run parallel to the conveying direction. The pivot axis of the first and second inclining joint in particular run parallel to one another.

The delivery sides in particular are located laterally of the movement path of the conveying unit, which is led along a longitudinal guidance device. The inclining mechanism in particular is designed in a manner such that the inclining towards the first and second delivery side is effected transversely to the conveying direction. The first inclining direction towards the first delivery side is accordingly opposite to the second inclining direction towards the second delivery side.

The first inclining joint is arranged on the conveying unit in particular towards the first delivery side relative to the second inclining joint. The first inclining joint is attached in particular to the inclining body.

The second inclining joint is arranged on the conveying unit in particular towards the second delivery side relative to the first inclining joint. The second inclining joint is attached in particular to the base body.

According to a further development of the invention, the first inclining joint is attached to the inclining body and the second inclining joint to the base body. The first and the second inclining joint are connected to one another via a first connecting element. The inclining mechanism now includes a third inclining joint with a third pivot axis, likewise for pivoting the inclining body towards the first delivery side, and a fourth inclining joint with a fourth pivot axis, likewise for pivoting the inclining body towards the second delivery side, as well as a second connecting element which connects the two inclining joints to one another.

The third inclining joint is arranged at the side of the first inclining joint, but fastened to the base body. The fourth inclining joint is arranged at the side of the second inclining joint, but fastened to the inclining body. Accordingly, the second connecting element runs counter to the first connecting element.

The first and the third geometric pivot axis of the first and the third inclining joint in particular lie on a common axis during the pivoting of the inclining body about the mentioned pivot axes.

The second and the fourth geometric pivot axis of the second and fourth inclining joint in particular lie on a common axis during the pivoting of the inclining body about the mentioned pivot axes.

The inclining joints are arranged on the base body or inclining body, in particular on a lateral edge termination. Accordingly, the pivot axes are also arranged on the lateral edge termination. The lateral arrangement of the pivot axes in particular permits a practically complete lowering of the inclining body onto the base body in the neutral conveying position.

According to the solution of present invention, the inclining body does not need to be spaced from the base body for ensuring a sufficient pivoting radius, as would be the case, for example, with a pivot axis arranged centrally between the base body and the inclining body.

The mentioned pivot axes of the inclining body are to be understood as geometric pivot axes. The inclining joints however can include physical pivots, which form the geometric pivot axes.

In particular, the inclining joints are designed as hinge joints. The inclining mechanism with regard to its design in particular can correspond to a swing-door hinge with or without restoring characteristics (spring effect). In particular, the inclining joints are of metal.

The connecting element can be flexurally rigid. It can be designed for example in a plate-shaped or rod-shaped manner. The connecting element in particular can be a strap hinge.

The connecting element can also be designed in a flexible manner, in particular in a flexurally limp manner. In this manner, the two hinge joints can be flexibly connected to one another. The connecting element can be a flexible tape, such as a textile tape or fabric tape. The connecting element can also be a cable or a cord.

The connecting element can be of metal or plastic.

The inclining body can be part of the conveying member. In particular, one can also envisage the conveying member being arranged on the inclining body, in particularly being attached to it and being inclinable together with this.

As mentioned, the conveying member includes a rest element, which forms a rest surface for the conveyed object. If the inclining body is part of the conveying member, the rest element in particular is formed by the inclining body itself

The conveyed object lies on the rest surface for the purpose of being conveyed. The rest element with its rest surface is then inclined relative the base body towards the side on pivoting the inclining body about one of the pivot axes of the inclining joints.

This leads to the conveyed object sliding or slipping from the rest surface on account of gravity. The conveyed object can, hence, be transferred onto a laterally arranged take-over device. The kinetic energy, which is transmitted onto the conveyed object during the sliding-away or slipping-away, is sufficient in order to transfer this object onto the take-over device.

In particular, the rest element is a plate element. The rest surface of the rest element in particular is designed in a plane manner.

The rest element can include a recess for receiving the conveyed object. Such a recess can be advantageous for example if the conveying member includes no encompassing frame

The rest surface of the take-over device in particular lies below or at the same height as the lowest point of the inclined rest surface of the rest element during the transfer of the conveyed object.

The take-over device can include, e.g., a rest table, such as a roller table, or an onward conveying device such as a conveying belt

The conveyed object can be a piece object. The conveyed object however can also be a bulk object, e.g., in the form of small parts or mass parts. Such small parts or mass parts can be, e.g., screws, screw closures, blanks, etc.

The base body can be, e.g., a plate element.

The encompassing frame in particular completely encompasses the rest surface of the rest element.

The features, which are disclosed in conjunction with the encompassing frame, also apply in particular to the first aspect of the invention.

The encompassing frame forms a lateral limitation for the conveyed object, in particular to the delivery sides. If the encompassing frame includes part-frames, in particular two part-frames, then in particular a part-frame each forms at least one lateral limitation for the conveyed object, to one of the two delivery sides.

The encompassing frame together with the rest surface of the rest element in particular forms a carrier shell for the conveyed object.

The encompassing frame or a part-frame of a multi-part encompassing frame is directly or indirectly mounted on the inclining body about a frame pivot axis via a frame joint and is pivotable relative to this inclining body via the frame pivot axis.

In particular, the frame pivot axis is arranged between the two delivery sides.

In particular, the frame pivot axis is arranged between the pivot axes of the inclining joints.

The encompassing frame or part-frame in particular is directly or indirectly mounted on the inclining body in manner such that the frame pivot axis is co-moved with the inclining body on pivoting the inclining body.

The encompassing frame or part-frame in particular is pivotable relative to the inclining body about the frame pivot axis in a manner such that the encompassing frame or the part-frame can be lowered to below the rest surface of the rest element or lifted to above the rest surface of the rest element, towards the delivery side, to which the inclining body is pivoted and thus releases a delivery opening for the conveyed object to the delivery side.

The encompassing frame or the part-frame in particular is pivotably mounted on the rest element.

The delivery opening defines a frameless section above the rest surface, via which section the conveyed object can slide or slip from the rest surface in an obstacle-free manner.

According to a further development, the conveying member includes a first part-frame and a second part-frame, which form a closed encompassing frame. In particular, this encompassing frame completely encompasses the rest surface.

The first part-frame in particular is directed towards the first delivery side and towards the delivery side forms a first frame section.

The second part-frame in particular is directed towards the second delivery side and towards the second delivery side forms a second frame section.

In particular, the part-frames form arm sections. In particular, the arm sections of the first and second part-frame are directed to one another.

In particular, the two part-frames are pivotable relative to the inclining body about a frame pivot axis of at least one frame joint independently of one another.

In particular, the two part-frames are pivotable relative to the inclining body about a common frame pivot axis of a frame joint independently of one another.

In particular, the frame pivot axis is arranged in the arm sections of the part-frames.

Considered in the conveying direction, the frame pivot-axis in particular is arranged between the pivot axes of the first and second inclining joint.

In particular, the frame pivot axis and the pivot axes of the inclining joints are arranged parallel to one another.

In particular, the frame pivot axis is arranged parallel to the conveying direction.

The control elements can be rigid actuation members, which are designed for pushing (compression), such as, e.g., push rods. Consequently, the control elements act as push members.

The control elements can be flexible or rigid or semi-rigid actuation members that are designed for pulling (tension). The control elements consequently act as pull members.

The control elements can be rigid actuating members that are designed for compression as well as tension. The control elements consequently act as push and pull members.

The encompassing frame or part-frame can be connected to the base body via at least one actuation member. The actuation member is articulately connected to the encompassing frame or part-frame via a first rotation axis and articulately connected to the base body via a second rotation axis.

In particular, the first rotation axis is arranged on an arm section of the part-frame

In particular, the actuation element is flexurally stiff. The actuation element can be a connecting rod.

In particular, the first rotation axis of the actuation member and the frame pivot axis are arranged offset to one another.

In this manner, on inclining the inclining body towards a delivery side, the encompassing frame or part-frame towards the respective delivery side is pivoted to above the rest surface and thus lifted and or to below the rest surface and thus lowered, by way of the actuation member whilst forming a delivery opening.

Since the encompassing frame or part-frame is mounted directly or indirectly on the inclining body, the lifting or lowering of the encompassing frame or part-frame is effected via a relative movement between the inclining body and base body thanks to the coupling of the encompassing frame or part-frame onto the base body by way of the actuation member.

This means that the pivoting of the inclining body relative to the base body towards a delivery side also activates the lifting or lowering of the encompassing frame or part-frame. Consequently, the lifting or lowering of the encompassing frame or part-frame is controlled by the pivoting movement of the inclining body relative to the base body.

In particular, the first and second rotation axes in particular run parallel to the frame pivot axis.

According to a first embodiment variant, considered in the conveying direction, the actuation member is fastened to the part-frame towards the frame pivot axis via the first rotation axis and is fastened to the base body towards the delivery side, which lies opposite to the delivery side, to which the part-frame is directed, via the second pivot axis.

The first rotation axis of the actuation member is arranged on a free arm section of the part-frame in a manner offset to the frame pivot axis towards that delivery side, which lies opposite to the delivery side, to which the part-frame is directed.

On inclining the inclining body towards the delivery side, to which the part-frame is directed, the part-frame is therefore lifted relative to the inclining body to above the rest surface whilst forming a delivery opening, by way of the actuation member.

According to a second embodiment variant, considered in the conveying direction, the actuation member is fastened on an arm section of the part-frame towards the delivery side, to which the part-frame is directed, via the first rotation axis, and is fastened to the base body towards the frame pivot axis via the second rotation axis.

The first rotation axis of the actuation member is arranged on an arm section of the part-frame in a manner offset to the frame pivot axis towards the delivery side, to which the part-frame is directed.

Thus on inclining the inclining body towards the delivery side, to which the part-frame is directed, the part-frame is lowered relative to the inclining body to below the rest surface whilst forming a delivery opening, by way of the actuation member.

The inclining body in particular includes at least one cam member, which is designed to interact with a cam guide of the conveying device, in order to thus pivot the inclining body into an inclined position. The cam member can be arranged towards a delivery side. The cam member can be rigidly connected to the inclining member.

The cam member can be a cam roller or a slide element.

The inclining body can include at least two cam members, which are each arranged on the inclining body towards one of the two delivery sides, which lie opposite one another.

The present invention also relates to a conveying device with at least one conveying unit as described above. The conveying device in particular includes a plurality of conveying units, which are successively arranged along a conveying direction.

The at least one conveying unit is movable along a longitudinal guidance device such as a guide rail, of the conveying device, in particular via guide means. The longitudinal guidance device in particular defines the movement path of the conveying unit.

The delivery sides in particular are arranged laterally of the movement path of the conveying units.

The conveying unit can be connected to a conveying vehicle via connecting means. The conveying unit in particular can be arranged on the conveying vehicle.

The conveying unit and the conveying vehicle in particular form a conveying module, which is movable along a conveying track/path of the conveying device. The conveying device accordingly includes a plurality of conveying modules, which are led successively in the conveying direction and which are each with a conveying member.

The conveying vehicle includes guide means, via which the conveying vehicle is movable along a longitudinal guidance device, such as a guide rail.

The connecting means can be arranged, for example, on the base body.

The guide means can be runner rollers, via which the conveying vehicle rolls along the longitudinal guidance device.

The guide means can be slide elements, via which the conveying vehicle slides along the longitudinal guidance device.

It is possible for the base body to be part of the conveying vehicle. I.e., the guide means are arranged on the base body.

The design and arrangement of the guide rail and conveying vehicle can be such that the conveying vehicle is an inner-runner or outer-runner.

The conveying vehicles of a conveying device can be designed as individual vehicles. This means that the conveying vehicles and with them the conveying modules are movable independently of one another.

The conveying vehicles of a conveying device can also be chained to one another into a conveying chain. For this, the conveying vehicles in particular are connected to one another via joint connections. The conveying vehicles in particular include suitable coupling means for creating the joint connection.

The conveying unit can also be connected to a conveying chain via the connecting means, which, e.g., are arranged on the base body, said conveying chain being led along a chain guide. The conveying chain is driven, for example.

The conveying device can include a cam guide, which, for the purpose of inclining the inclining body towards the delivery side, can interact with a cam member on the conveying unit. The cam member in particular is arranged on the inclining body.

The cam guide can be arranged relative to the conveying unit in a stationary manner.

The cam guide can be engaged and disengaged so that the inclining body can be selectively inclined at a delivery location.

The inclination of the inclining body is accordingly positively actuated via the cam guide.

The conveying unit can include a transmission gearing, which interacts with the inclining mechanism in a manner such that the inclination of the inclining body is amplified with respect to the deflection of the cam-guided cam member.

The method for conveying and delivering or transferring conveyed objects with a conveying device, as described above, is characterised by the following steps:
moving the at least one conveying unit along a movement path;
inclining the inclining body towards the first delivery side by way of pivoting the inclining body about the first pivot axis or inclining the inclining body towards the second, opposite delivery side by way of pivoting the inclining body about the second pivot axis, by way of lifting a cam member on the inclining body by way of a cam guide.

According to a further development of the method, the conveying unit includes a single-part or multi-part encompassing frame, wherein simultaneously with the inclining of the inclining body towards the first or second delivery side, the encompassing frame or a part-frame of a multi-part encompassing frame at the respective delivery side is lifted to above the rest surface or is lowered to below the rest surface and a delivery opening is therefore released to the delivery side, and the conveyed object is transferred to a take-over device by way of sliding or slipping away from the inclined rest surface.

The inclining mechanism according to the invention permits a guided inclining of the inclining body towards two delivery sides, which lie opposite to one another, wherein the inclining body is mounted in a stable manner in the inclined delivery position during the pivoting procedure as well as in the neutral conveying position during the conveying, despite the articulated connection to the base body. In the neutral conveying position, the rest surface in particular is aligned horizontally.

### BRIEF DESCRIPTION OF THE DRAWINGS

The subject matter of the invention is hereinafter explained in more detail by way of preferred embodiment examples which are represented in the accompanying figures. Each represented schematically are:

FIG. 1 is a perspective view of a conveying device with conveying units according to the invention, according to a first embodiment;

FIG. 2 is a perspective view of the conveying unit according to the first embodiment with the rest surface in the neutral conveying position;

FIG. 3 is a perspective view of the conveying unit according to the first embodiment with the rest surface in the inclined delivery position;

FIG. 4 is a further perspective view of the conveying unit according to the first embodiment with the rest surface in the inclined delivery position;

FIG. 5 is a perspective view of a conveying unit according to the invention, according to a second embodiment with the rest surface in the neutral conveying position;

FIG. 6 is a perspective view of the conveying unit according to the second embodiment with the rest surface in the inclined delivery position.

### DETAILED DESCRIPTION OF THE INVENTION

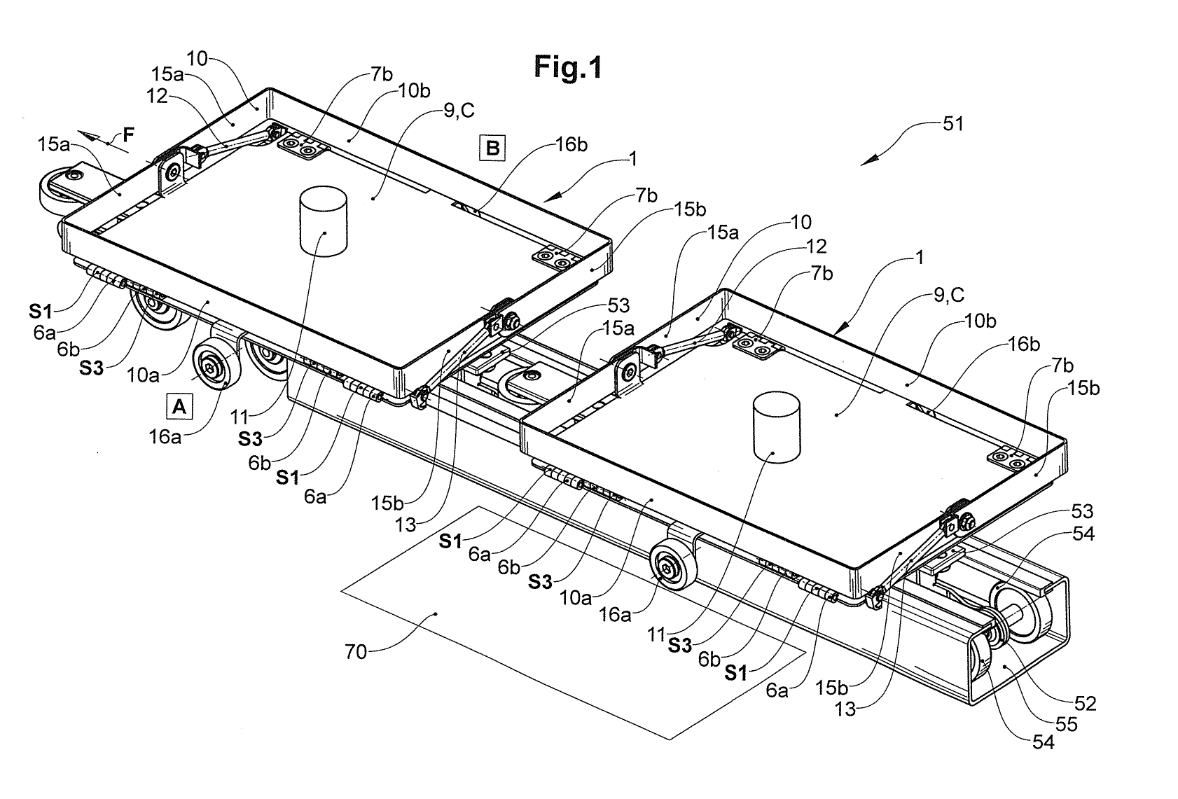

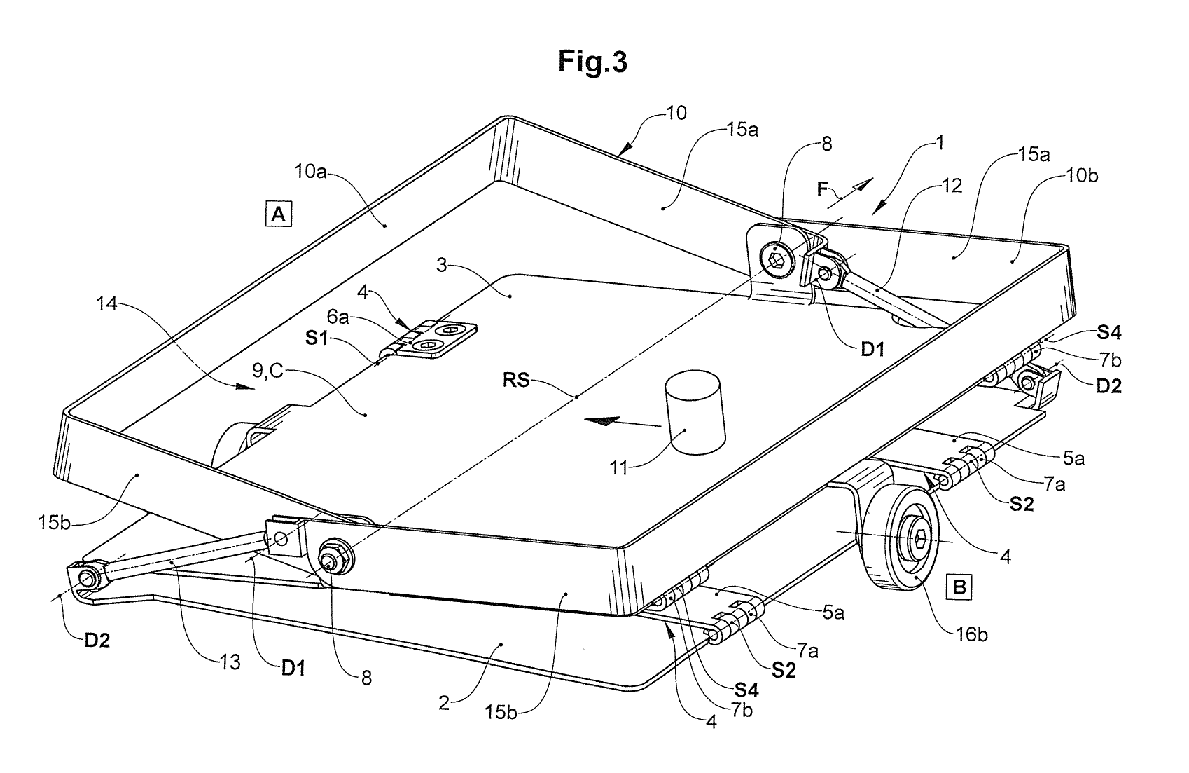

The conveying unit 1, 21 according to the FIGS. 1 to 6 includes a plate-like base body 2 as well as a plate-like inclining body 3a, which, together with a two-part encompassing frame 10, forms a conveying member 3. The plate-like inclining body 3a forms the rest element 9 of the conveying member 3. The rest element 9 forms a plane rest (support) surface C for the conveyed object 11.

The encompassing frame 10 forms a lateral limitation for the object 11 to be conveyed, so that this cannot slip from the rest surface C during the conveying, e.g. by way of braking or accelerating the conveying unit 1.

The conveying unit 1 moreover includes an inclining mechanism with a first inclining joint 6a, which forms a first pivot axis S1, and with a second inclining joint 7a, which forms a second pivot axis S2. The two inclining joints 6a, 7a are rigidly connected to one another via a connecting plate 5a.

The first inclining joint 6a is arranged towards the first delivery side A and connects the inclining body 3a to the connecting plate 5a. In this manner the inclining body 3a is pivotable relative to the connecting plate 5a and also relative to the base plate 2 about the first pivot axis S1 towards the first delivery side A into an inclined position.

The second inclining joint 7a is arranged towards a second delivery side B opposite to the first delivery side A and connects the base body 2 to the connecting plate 5a. In this manner, the inclining body 3a together with the connecting plate 5a is pivotable relative to the base plate 2 towards the second delivery side B about the second pivot axis S2, likewise into an inclined position.

The inclining mechanism moreover includes a third inclining joint 6b with a third pivot axis S3 likewise for pivoting the inclining body 3a towards the first delivery side A, and a fourth inclining joint 7b with a fourth pivot axis S4 likewise for pivoting the inclining body 3a towards the second delivery side B. The third and the fourth inclining joint 6b, 7b are rigidly connected to one another via a second connecting plate 5b.

The third inclining joint 6b is arranged at the side of the first inclining joint 6a but fastened to the base body 2. The fourth inclining joint 7b is arranged at the side of the second inclining joint 7a but is fastened to the inclining body 3a. Accordingly, the second connecting plate 5b runs counter to the first connecting plate 5a. The stability of the design can be increased by way of this.

The first and the third pivot axis S1, S3 of the first and third inclining joint 6a, 6b lie on a common axis during the pivoting of the inclining body 3a about these pivot axes S1, S3.

The second and fourth geometric pivot axis S2, S4 of the second and fourth inclining joint 7a, 7b lie on a common axis during the pivoting of the inclining body 3a about the mentioned pivot axes S2, S4.

The inclining joints 6a, 7a; 6b, 7b are arranged on the base body 2 and the inclining body 3a respectively, in particular on a lateral edge termination to the delivery side A, B. Accordingly, the pivot axes S1, S2, S3, S4 are also arranged on the lateral edge termination.

In particular, this permits a practically complete lowering of the inclining body 3a onto the base body 2 in the neutral conveying position.

According to the inventive solution for ensuring a sufficient pivoting radius, the inclining body 3a does not therefore need to be spaced from the base body 2, as would otherwise be the case for example with a pivot axis arranged centrally between the base body and the inclining body.

The rest surface C of the rest element 9 can therefore be selectively pivoted to the first delivery side A by way of pivoting the inclining body 3a about the pivot axis S1, S3 of the first and third inclining joint 6a, 6b, and to the opposite, second delivery side B by way of pivoting the inclining body 3a about the pivot axis S2, S4 of the second and fourth inclining joint 7a, 7b.

The first and the second inclining joint 6a, 7a with the connecting plate 5a, as well as the third and fourth inclining joint 6b, 7b with the second connecting plate 5b are each arranged in pairs. This increases the stability of the design, in particular on pivoting.

The first and the second inclining joint 6a, 7a with the connecting plate 5a, as well as the third and the fourth inclining joint 6b, 7b with the second connecting plate 5b however can also be each arranged individually.

In a modified embodiment, the third and fourth inclining joint 6b, 7b with the second connecting plate 5b can also be omitted.

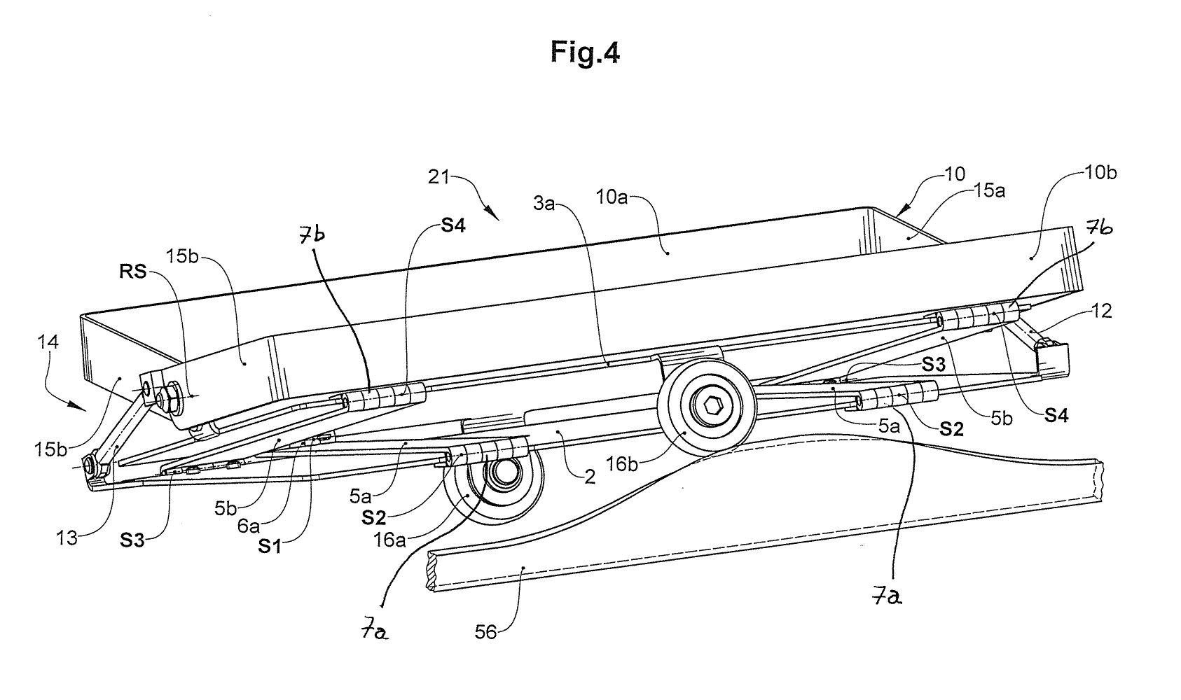

A cam roller 16a, 16b for the positive actuation of the inclination of the inclining body 3a is arranged on the inclining body 3a towards both delivery sides A, B. The cam rollers 16a, 16b interact with a cam guide 56 of the conveying device 51 by way of at least one cam roller 16a, 16b rolling on a running surface of the cam guide 56 at least for inclining the inclining body 3a. The cam roller 16a, 16b rolling on the running surface and, with this, the inclining body 3a, are lifted at the side of this cam roller 16a, 16b by way of an ascent of the mentioned running surface. The lifting of the inclining body 3a at one side effects an inclining of this (see FIG. 4).

The two-part encompassing frame 10 includes two U-shaped part-frames 10a, 10b each with two arm sections 15a, 15b. The part-frames 10a, 10b with the frame section are each aligned to one of oppositely lying delivery slides A, B and thus form a lateral limitation to the delivery sides A, B.

Accordingly, the U-shaped part-frames 10a, 10b lie opposite one another, wherein these are directed towards one another with their arm sections 15a, 15b. The arm sections 15a, 15b of the part-frames 10a, 10b are mounted on the rest element 9 via a common frame pivot axis RS of a frame joint and are pivotable relative to the rest element 9 as well as independently of one another.

The two part-frames 10a, 10b are moreover each connected to the base body 2 via an articulately attached actuation rod 12, 13; 22, 23.

The actuation rod 12, 13; 22, 23 is articulately fastened to an arm section 15a, 15b of the part-frame 10a, 10b in each case via a first rotation axis D1 and is pivotable relative to this arm section about the first rotation axis D1. The first rotation axis D1 runs parallel to the frame pivot axis RS.

The actuation rod 12, 13, 22, 23 is moreover articulately fastened to the base body 2 via a second rotation axis D2 and is pivotable relative to this about the second rotation axis D2. The fastening is effected via a fastening tab on the base body 2.

According to a first embodiment according to FIGS. 1 to 4, the actuating rod 12, 13 is fastened to a free arm section 15a, 15b of the part-frame 10a, 10b. The first rotation axis D1 is arranged offset to the frame pivot axis RS towards the end of the free arm section 15a,15b.

The actuation rod 12, 13 is moreover fastened to the base body 2 in each case towards the oppositely lying delivery side A, B, to which the free arm sections 15a, 15b of the respective part-frame 10a, 10b are directed. Accordingly, departing from the first rotation axis D1, the actuation rod 12, 13 runs obliquely downwards towards the second rotation axis D2 in the direction of the opposite delivery side A, B.

If the rest element 9 is now pivoted to one of the two delivery sides A, B via one of the two pivot axis pairs S1, S3; S2, S4 of the inclining joints 6a, 6b; 7a, 7b, then by way of the coupling of the part-frames 10a, 10b onto the base body 2 via an actuation rod 12, 13, the part-frame 10a, 10b, which is directed to the delivery side A, B, to which the inclining body 3a is pivoted is lifted to above the rest surface C of the rest element 9 amid the formation of a delivery opening 14.

This is effected by way of the actuation rod 12, 13 pressing the arm section 15a, 15b downwards in the region of the first rotation axis D1 by way of the relative movement between the inclining body 3a and the base plate 2. The frame pivot axis RS thereby acts in the manner of a rocker, which has the effect that the part-frame section, which is arranged on the other side of the frame pivot axis RS, is pivoted upwards.

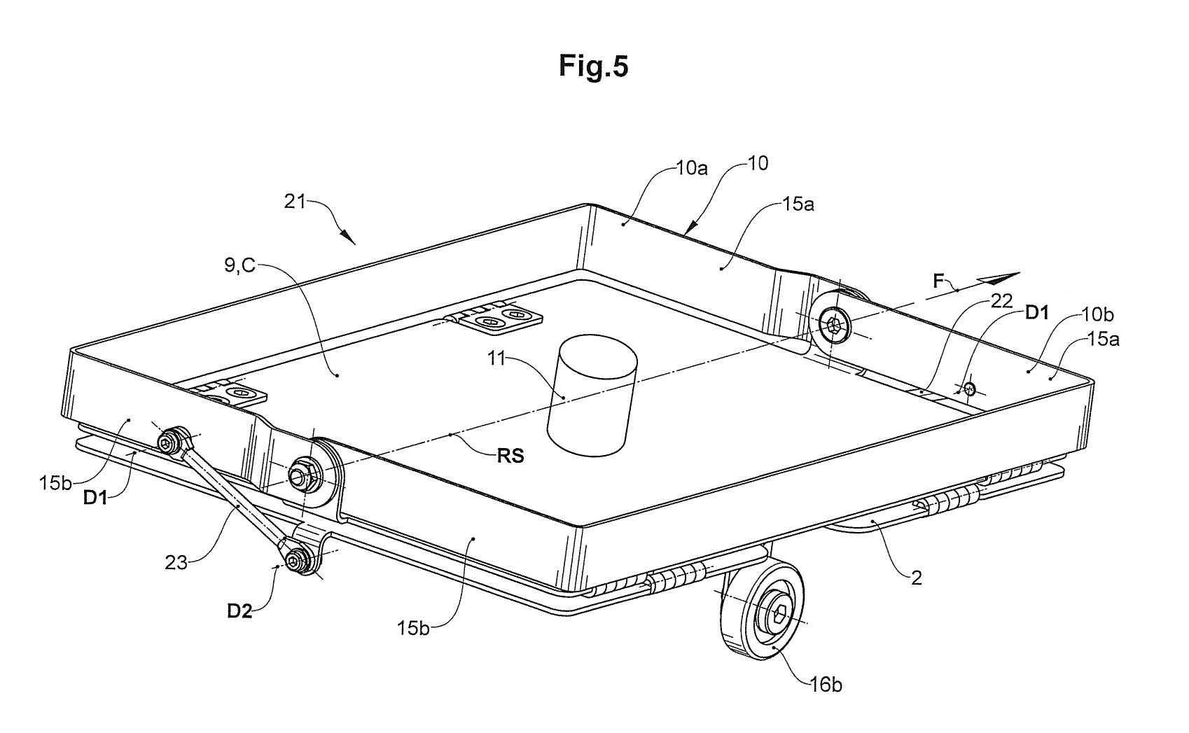

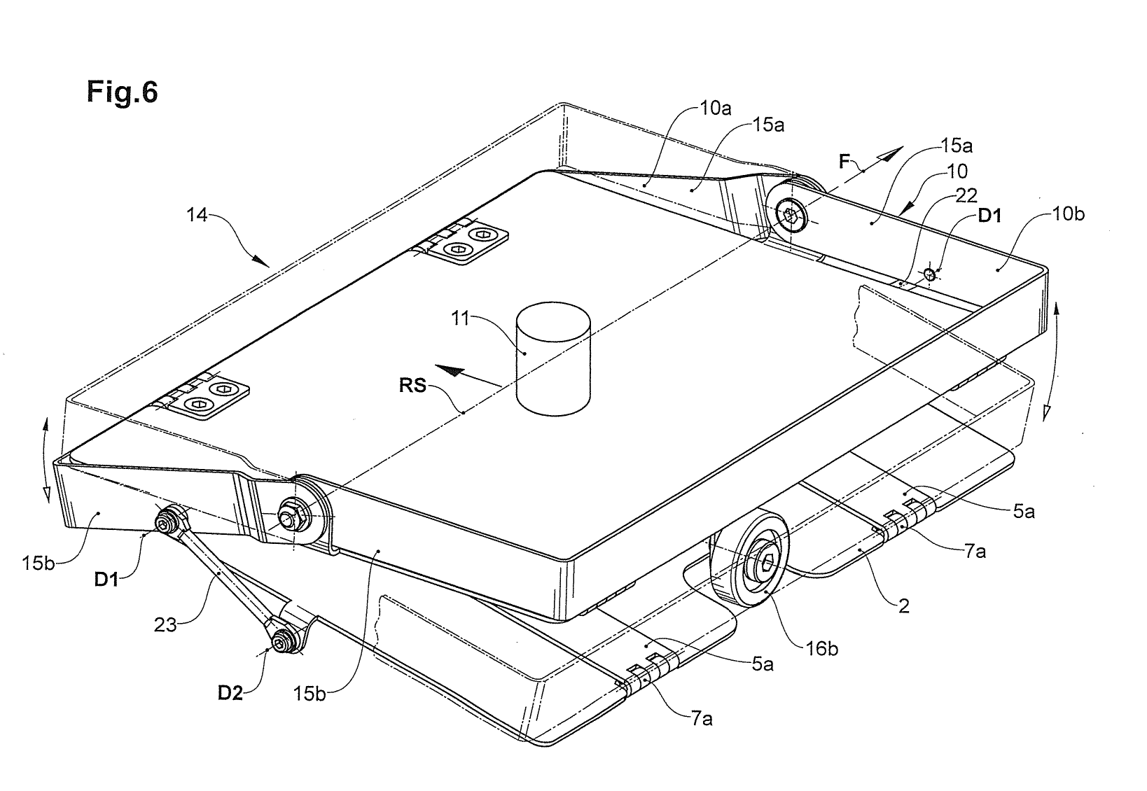

According to a second embodiment according to FIGS. 5 and 6, the first rotation axis D1 of the actuation rod 22, 23 is arranged offset to the frame pivot axis RS towards the delivery side, at which the encompassing frame 10 is to be lowered.

The actuation rod 22, 23 is moreover fastened to the base body 2 towards the delivery side A, B, to which the arm sections 15a, 15b of the respective part-frame 10a, 10b are directed. The second rotation axis D2 is thereby arranged below the frame pivot axis RS.

Accordingly, departing from the first rotation axis D1, the actuation rod 22, 23 runs obliquely downwards in the direction of the opposite delivery side A, B towards the second rotation axis D2.

If the rest element 9 is now pivoted to one of the two delivery sides A, B via one of the two pivot axis pairs S1, S3; S2, S4 of the inclining joints 6a, 6b, 7a, 7b, then by way of the coupling of the part-frame 10a, 10b onto the base body 2 via an actuation rod 22, 23, the part-frame 10a, 10b, which is directed to the delivery side A, B, towards which the inclination body 3a is pivoted is lowered to below the rest surface C of the rest element 9 amid the formation of a delivery opening 14.

This is effected by way of the actuation rod 22, 23 pressing the arm section 15a, 15b downwards in the region of the first rotation axis D1 due to the relative movement between the inclining body 3a and the base plate 2.

The conveyed object 11 can slide in the indicated arrow direction through the delivery opening 14 away from the inclined rest surface C due to gravity by way of lifting or lowering the encompassing frame 10 in the manner described above.

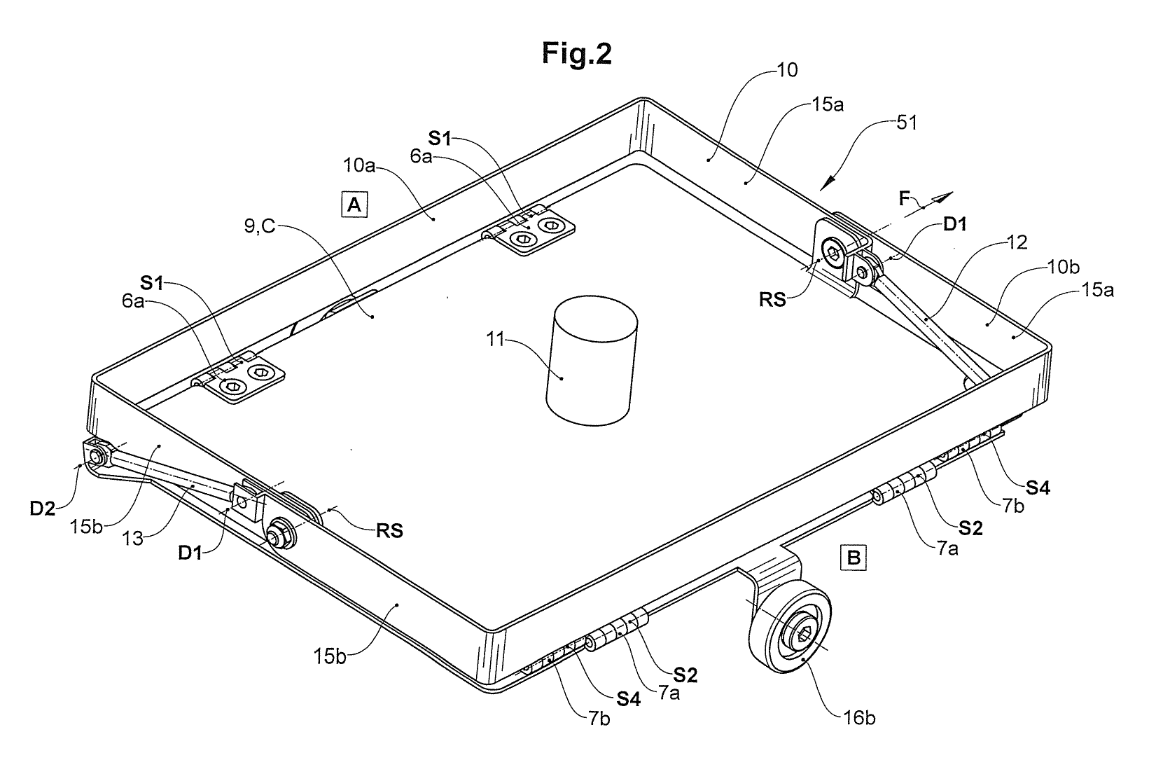

FIG. 1 shows a conveying device 51 with a plurality of conveying units 1 according to the invention, which are arranged successively in the conveying direction F. The rest surfaces C of the conveying units 3, as also in FIG. 2, are situated in the horizontal position in the neutral conveying position.

The conveying units 3 are each arranged on conveying vehicles 53 and with these form a conveying module. The conveying vehicles 53 of the conveying modules are connected to one another into a conveying chain via suitable joint connections.

The conveying vehicles 53 include runner rollers 54, via which these are moved along a guide rail 55. The runner rollers 54 run along the guide rail 55 during the movement of the conveying vehicles 53 in the conveying direction F. The guide rail 55 accordingly sets the movement path of the conveying units 1.

A transfer device 70, e.g., in the form of a take-over table can be arranged laterally of the guide rail 55, to which take-over device the conveyed objects 11 can be transferred by way of sliding-away from the inclined rest surface C of the conveying unit 1. A take-over conveyor can also be present instead of the take-over table.

1. A conveying unit for a conveying device for conveying objects to be conveyed, wherein the conveying unit comprises a base body, a conveying member with a rest element that forms a rest surface and for receiving a conveyed object (11), further comprising an inclining body that is connected to the conveying member, and an inclining mechanism for inclining the inclining body and, with this body, also the rest surface, with respect to the base body towards a delivery side for the purpose of delivering the conveyed object,
wherein the conveying member comprises a single-part or multi-part encompassing frame that at least partly encompasses the rest surface of the rest element for the object to be conveyed and can therefore secure the conveyed object against sliding away from the rest surface, and the encompassing frame can be lifted to above the rest surface or be lowered to below the rest surface via control elements on the conveying unit, on inclining the inclining body to the delivery side.

2. A conveying unit for a conveying device for conveying objects to be conveyed, wherein the conveying unit comprises a base body, a conveying member with a rest element that forms a rest surface for receiving a conveyed object, further comprising an inclining body that is connected to the conveying member, and an inclining mechanism for inclining the inclining body and, with this body, also the rest surface, with respect to the base body towards a delivery side for the purpose of delivering the conveyed object,
wherein the inclining mechanism comprises a first inclining joint with a first pivot axis for pivoting the inclining body towards to a first delivery side, and a second inclining joint with a second pivot axis for pivoting the inclining body towards a second delivery side that lies opposite the first delivery side, as well as a connecting element that connects the two inclining joints to one another.

3. The conveying unit according to claim 2, wherein the conveying member comprises a single-part or multi-part encompassing frame that at least partly encompasses the rest surface of the rest element for the object to be conveyed and can therefore secure the conveyed object against sliding away from the rest surface, and the encompassing frame can be lifted to above the rest surface or lowered to below the rest surface via control elements on the conveying unit on inclining the inclining body to the delivery side.

4. The conveying unit according to claim 1, wherein the conveying member comprises the inclining body.

5. The conveying unit according to claim 1, wherein the conveying member is arranged on the inclining body and is inclinable together with this.

6. The conveying unit according to claim 2, wherein the first inclining joint is arranged on the conveying unit towards the first delivery side relative to the second inclining joint, and the second inclining joint is arranged on the conveying unit towards the second delivery side relative to the first inclining joint.

7. The conveying unit according to claim 1, wherein the encompassing frame or a part-frame of a multi-part encompassing frame is directly or indirectly mounted on the inclining body and is pivotable relative to the inclining body about a frame pivot axis via a frame joint.

8. The conveying unit according to claim 1, wherein the conveying member comprises a first part-frame and a second part-frame that form a closed encompassing frame, wherein the two part-frames are pivotable relative to the rest surface independently of one another about a frame pivot axis of a frame joint.

9. The conveying unit according to claim 1, wherein the encompassing frame or part-frame is connected to the base body via at least one control element that is designed as an actuation member, wherein the actuation member is articulately connected to the encompassing frame or part-frame via a first rotation axis and is articulately connected to the base body via a second rotation axis.

10. The conveying unit according to claim 1, wherein the inclining body comprises a cam member, via which the inclining body, interacting with a cam guide, can be inclined towards a delivery side.

11. A conveying device with at least one conveying unit according to claim 1, wherein the conveying device comprises a longitudinal guidance device, and the least one conveying unit is arranged on a conveying vehicle that is movable along the longitudinal guidance device.

12. The conveying device according to claim 11, wherein the conveying vehicle comprises at least one runner roller that is arranged in a manner rolling along the longitudinal guidance device.

13. The conveying device according to claim 11, wherein the conveying device comprises a cam guide that, for the purpose of inclining the inclining body to a delivery side, can interact with a cam member on the inclining body.

14. A method for conveying and delivering conveyed objects with a conveying device according to claim 11, comprising the steps of:
moving the at least one conveying unit along a movement path;
inclining the inclining body to a delivery side about the first pivot axis or the second pivot axis by way of lifting a cam member on the inclining body by way of a cam guide;
transfer of the conveyed object by way of the sliding of the conveyed object from the rest surface onto a take-over device.

15. The method according to claim 14, wherein the conveying member comprises a single-part or multi-part encompassing frame, wherein the following steps are carried out simultaneously with the inclining of the inclining body towards the first or second delivery side,
lifting or lowering the encompassing frame or a part-frame at the respective delivery side and releasing a delivery opening;
transferring the conveyed object by way of the sliding-away of the conveyed object from the inclined rest surface through the delivery opening onto the take-over device.

16. The conveying unit according to claim 2, wherein the conveying member comprises the inclining body.

17. The conveying unit according to claim 2, wherein the conveying member is arranged on the inclining body and is inclinable together with this.

18. The conveying unit according to claim 3, wherein the first inclining joint is arranged on the conveying unit towards the first delivery side relative to the second inclining joint, and the second inclining joint is arranged on the conveying unit towards the second delivery side relative to the first inclining joint.

19. The conveying unit according to claim 3, wherein the encompassing frame or a part-frame of a multi-part encompassing frame is directly or indirectly mounted on the inclining body and is pivotable relative to the inclining body about a frame pivot axis via a frame joint.

20. The conveying unit according to claim 3, wherein the conveying member comprises a first part-frame and a second part-frame that form a closed encompassing frame, wherein the two part-frames are pivotable relative to the rest surface independently of one another about a frame pivot axis of a frame joint.
